(19) United States
(12) Patent Application Publication
(10) Pub. No.: US 2011/0142095 A1
(43) Pub. Date: Jun. 16, 2011

(54) METHOD AND APPARATUS FOR PERIODIC SOUNDING REFERENCE SIGNAL TRANSMISSION FROM MULTIPLE ANTENNAS IN A WIRELESS COMMUNICATION SYSTEM

(76) Inventors: Yu-Hsuan Guo, Taipei (TW); Li-Chih Tseng, Taipei (TW); Richard Lee-Chee Kuo, Taipei (TW); Ming-Che Li, Taipei (TW); Meng-Hui Ou, Taipei (TW)

(21) Appl. No.: 12/965,490

(22) Filed: Dec. 10, 2010

Related U.S. Application Data
(60) Provisional application No. 61/285,197, filed on Dec. 10, 2009.

(51) Int. Cl. H04B 7/02; H04L 27/04; H04B 1/713

(52) U.S. Cl. 375/133; 375/295; 375/135; 375/267; 375/E01.033

(57) ABSTRACT

A method for transmitting sounding reference signals from a user equipment having multiple antennas is disclosed. The user equipment may concurrently send two periodic sounding reference signals. A first sounding reference signal is sent from a single antenna. A second sounding reference signal is sent from multiple antennas. Transmission of the sounding reference signal from multiple antennas is triggered when the user equipment receives activation signal from the network.

### CROSS REFERENCE TO RELATED APPLICATIONS

This application claims the benefit of U.S. Provisional Application No. 61/285,197, filed on Dec. 10, 2009 and titled “Method and Apparatus of Periodic SRS Transmission from Multiple Antennas and Contention Based Uplink Transmission in a Wireless Communication System,” the contents of which are incorporated herein by reference.

### BACKGROUND

The present invention relates to wireless communication systems and, more particularly, to transmission of sounding reference signals from a multi-antenna transceiver.

In a wireless communication system, a base station, or node B, may receive sounding reference signals from user equipments. The sounding reference signals may be used by the base station to estimate characteristics of communication channels between the antennas of the base station and the user equipment. The base station may allocate communication resources based on analysis of the channel characteristics. The allocated communication resources are a combination of frequencies and time intervals. The time intervals may be parts of subframes that are parts of frames.

Channel characteristics may change over time, for example, when the user equipment or other objects move. Accordingly, the sounding reference signals may occasionally be resent. More frequent transmission of sounding reference signals may provide improved estimation of channel characteristics. However, the time during which a sounding reference signal is transmitted is overhead time that might otherwise be used to communicate user data. Furthermore, the need for channel estimates may depend on communication traffic.

### SUMMARY OF THE INVENTION

In one aspect the invention provides a method for transmitting sounding reference signals from a user equipment having a plurality of antennas. The method includes: receiving downstream channel information having a DCI format; and transmitting a sounding reference signal when triggered by the DCI format, wherein the DCI format has an associated transmission time interval and the sounding reference signal is transmitted in the associated transmission time interval.

In another aspect the invention provides a method for transmitting sounding reference signals from a user equipment having a plurality of antennas. The method includes: transmitting a first sounding reference signal from one of the plurality of antennas, wherein transmitting the first sounding reference signal repeats at a first period; and transmitting a second sounding reference signal from at least two of the plurality of antennas, wherein transmitting the second sounding reference signal repeats at a second period.

In another aspect the invention provides a wireless communication device. The wireless communication device includes: a plurality of transmitters configured to supply radio-frequency signals; a plurality of antennas configured to receive the radio-frequency signals from the plurality of transmitters; a processor configured to execute a program; and a memory coupled to the processor for storing the program, wherein the program instructs the processor to: command transmission of a first sounding reference signal from one of the plurality of antennas, wherein transmitting the first sounding reference signal repeats at a first period; and command transmission of a second sounding reference signal from at least two of the plurality of antennas, wherein transmitting the second sounding reference signal repeats at a second period.

These and other aspects of the invention are more fully comprehended upon review of this disclosure and the accompanying drawings.

### BRIEF DESCRIPTION OF THE DRAWINGS

FIG. 1 is a diagram of a multiple access wireless communication system in accordance with aspects of the invention.

FIG. 2 is a block diagram of a two multi-antenna transceivers in accordance with aspects of the invention.

FIG. 3 is a block diagram of a wireless communication device in accordance with aspects of the invention.

FIG. 4 is a diagram of a program for a wireless communication device in accordance with aspects of the invention.

FIGS. 5A-C are timing diagram illustrating sounding reference signals in accordance with aspects of the invention.

FIG. 6 is a flowchart of a process for transmitting sounding reference signals in accordance with aspects of the invention.

### DETAILED DESCRIPTION

The exemplary wireless communication systems, devices, and related methods described below employ a wireless communication system supporting broadband service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP2 UMB (Ultra Mobile Broadband), WiMax, or some other modulation techniques.

In particular, the exemplary wireless communication systems, devices, and methods described below may be designed to support one or more standards such as the standards offered by a consortium named “3rd Generation Partnership Project” referred to herein as 3GPP, including Document Nos. 3GPP TR 36.213 (“Evolved Universal Terrestrial Radio Access (E-UTRA): Physical Layer Procedures (Release 8)”), 3GPP TSG-RAN-WG1 R1-094576 (“SRS Transmission in LTE-A”), and 3GPP TSG-RAN-WG1 R1-094653 (“Channel Sounding Enhancements for LTE-Advanced”). The standards and documents listed above are hereby expressly incorporated herein.

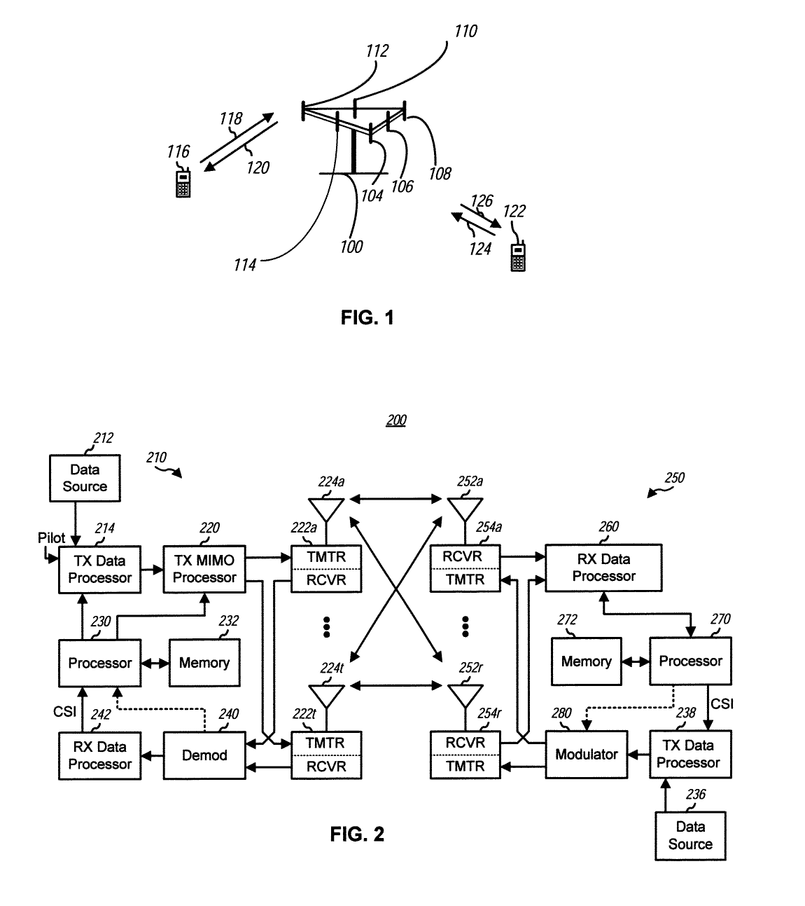

FIG. 1 is a diagram of a multiple access wireless communication system in accordance with aspects of the invention. A radio access network (RAN) 100 includes multiple antenna groups, one including antennas 104 and 106, another including antennas 108 and 110, and an additional including antennas 112 and 114. In FIG. 1, two antennas are shown for each antenna group, however, more or fewer antennas may be included for each antenna group. A first user equipment (UE) 116 is in communication with antennas 112 and 114, where antennas 112 and 114 transmit information to the first UE 116 over a forward link 120 and receive information from access terminal 116 over a reverse link 118. A second UE 122 is in communication with antennas 104 and 106, where antennas 104 and 106 transmit information to the second UE 122 over a forward link 126 and receive information from access terminal (AT) 122 over a reverse link 124. The forward and reverse links may operate using frequency division duplexing (FDD) or time division duplexing (TDD).

Which of antennas the RAN 100 uses to communicate with the first and second UEs 116, 122 may vary with the characteristics of the various channels between the antennas of the RAN 100 and the antennas of the first and second UEs 116, 122. Accordingly, various known signals may be transmitted between the UEs and the RAN to enable analysis of channel characteristics.

The radio access network is generally a fixed station or base station used for communicating with the terminals and may also be referred to as a node B, an enhanced node B, or some other terminology. The UEs are commonly mobile devices such as telephone devices.

FIG. 2 is a block diagram of a two multi-antenna transceivers used in a multiple-input multiple-output (MIMO) system 200. The system includes a first transceiver 210 (which may be used in the radio access network of FIG. 1) and a second transceiver 250 (which may be used in the UEs of FIG. 1). At the first transceiver 210, traffic data for a first data stream is provided from a data source 212 to a transmit data processor 214. The transmit data processor 214 formats, codes, and interleaves the traffic data based on a particular coding scheme selected to provide coded data.

The coded data may be multiplexed with pilot data using orthogonal frequency division modulation (OFDM) techniques. The pilot data is typically a known data pattern that is processed in a known manner and may be used at the receiver system to estimate the channel response. The multiplexed pilot and coded data is then modulated (i.e., symbol mapped) based on a particular selected modulation scheme (e.g., BPSK, QSPK, M-PSK, or M-QAM) to provide modulation symbols. The data rate, coding, and modulation for the data stream may be determined by instructions performed by a processor 230.

The modulation symbols are then provided to a transmit MIMO processor 220, which may further process the modulation symbols (e.g., using beamforming, BLAST, Alamouti, SORTD, or other schemes). The transmit MIMO processor 220 then provides modulation symbol streams to each of multiple transmitters 222a-222t.

Each transmitter 222 receives and processes one of the modulation symbol streams to provide a radio-frequency signal. The transmitters 222a-222t include circuitry such as filters, modulators, and amplifiers to provide modulated signals suitable for transmission over a MIMO channel. The radio-frequency signals from the transmitters 222a-222t are then transmitted from multiple antennas 224a-224t.

At the second transceiver 250, the modulated signals transmitted from the first transceiver 210 are received by multiple antennas 252a-252r. The received signal from each antenna 252 is provided to one of multiple receivers 254a-254r. Each receiver 254 conditions (e.g., filters, amplifies, and downconverts) a respective received signal, digitizes the conditioned signal to provide samples, and further processes the samples to provide a received symbol stream.

A receive data processor 260 receives and processes the received symbol streams from the receivers 254 based on a particular receiver processing technique to provide detected symbol streams. The receive data processor 260 demodulates, deinterleaves, and decodes each detected symbol stream to recover the traffic data. The processing by the receive data processor 260 is complementary to that performed by the transmit MIMO processor 220 and the transmit data processor 214 at the first transceiver 210. A second processor 270 periodically determines control aspects of operation of the receive data processor 260.

In response to certain messages, the second transceiver 250 sends messages to the first transceiver 210. Upstream messages are processed by a TX data processor 238 that also receives traffic data from a second data source 236. Processed data from the TX data processor 238 is modulated by a modulator 280, conditioned by transmitters 254a through 254r, and transmitted back to the first transceiver 210 via antennas 252a-r. Some of the messages sent by the second transceiver 250 are sounding reference signal (SRS) transmissions that may be sent from a single one or multiple of the antennas 252a-r.

At the first transceiver 210, the signals from the second transceiver 250 are received by antennas 224a-t, conditioned by receivers 222a-t, demodulated by a demodulator 240, and processed by a RX data processor 242 to extract the upstream messages transmitted by the second transceiver 250.

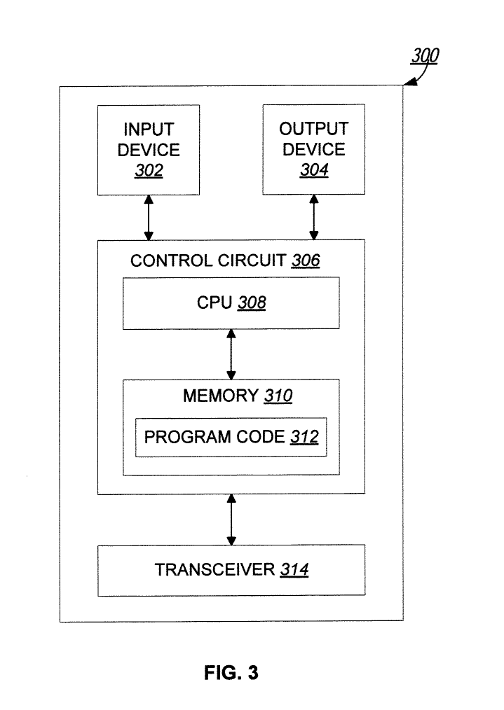

FIG. 3 is a block diagram of a wireless communication device in accordance with aspects of the invention. The wireless communication device 300 may be utilized in the user equipment in the wireless communication system of FIG. 1. For the sake of brevity, FIG. 3 only shows an input device 302, an output device 304, a control circuit 306, a central processing unit (CPU) 308, a memory 310, a program 312, and a transceiver 314 of the communication device 300. In the communication device 300, the control circuit 306 executes the program 312 in the memory 310 through the CPU 308 thereby controlling an operation of the communication device 300. The communication device 300 can receive signals input by a user through the input device 302, such as a keyboard, and can output images and sounds through the output device 304, such as a display or speaker. The transceiver 314 is used to receive and transmit wireless signals. The transceiver 314 delivers received signals to the control circuit 306 and wirelessly transmits signals generated by the control circuit 306. In some implementations of the wireless communication device 300, the transceiver 314 may follow the principles illustrated in the transceivers of FIG. 2. From a perspective of a communication protocol framework, the transceiver 314 may be associated with portions of Layer 1, and the control circuit 306 may be associated with portions of Layer 2 and Layer 3.

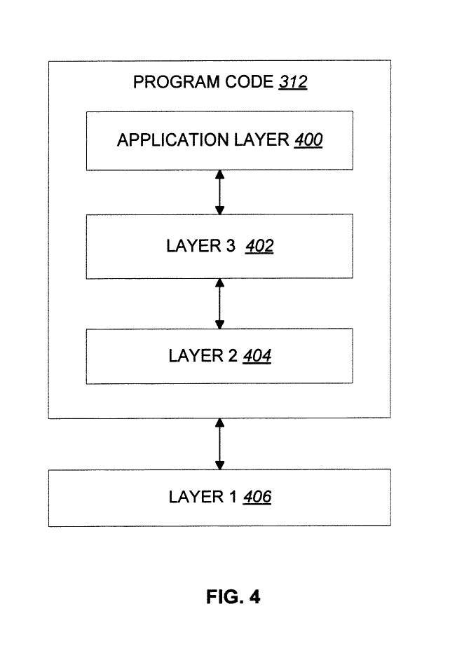

FIG. 4 is a diagram of the program 312 for the wireless communication device 300 of FIG. 3. The program 312 includes an application layer 400, a Layer 3 402, and a Layer 2 404 and is coupled to a Layer 1 406. The Layer 3 402 performs radio resource control. The Layer 2 404 includes a radio link control (RLC) layer and a Medium Access Control (MAC) layer and performs link control. The Layer 1 418 performs physical connections. In some embodiments, the Layer 1 may transmit sounding reference signals at time signaled by a higher layer.

In the following discussion, the invention is described mainly in the context of the 3GPP architecture reference model. However, it is understood that with the disclosed information, one skilled in the art could readily adapt for use and implement aspects of the invention in a 3GPP2 network architecture or in other network architectures.

As described in 3GPP TR 36.213, in LTE systems, a UE periodically transmits a sounding reference signal (SRS) from a single antenna. The SRS bandwidth, frequency hopping bandwidth, and periodicity for the UE are semi-statically configured by higher layers. There are eight orthogonal sequences for SRS transmission in one cell, and frequency division multiplexing (FDM) with factor two is used. SRS is generally a layer 1, or physical layer, operation. However, in LIE, higher layers configure SRS operation.

In LTE-A, which uses single user MIMO (SU-MIMO), uplink transmission from a UE may be configured to use up to four antennas. At a baseline level, SRS transmissions in LTE-A are non-precoded and antenna specific. Thus, transmission resources used for SRS may present a capacity problem and the number of supportable UEs with SRS transmissions in a subframe is decreased. Rather than increase the total usable SRS resources, another approach for providing SRS enhancement is to reduce the required SRS resources for each UE. In order to reduce overhead, the SRS enhancements work on top of existing SRS resources.

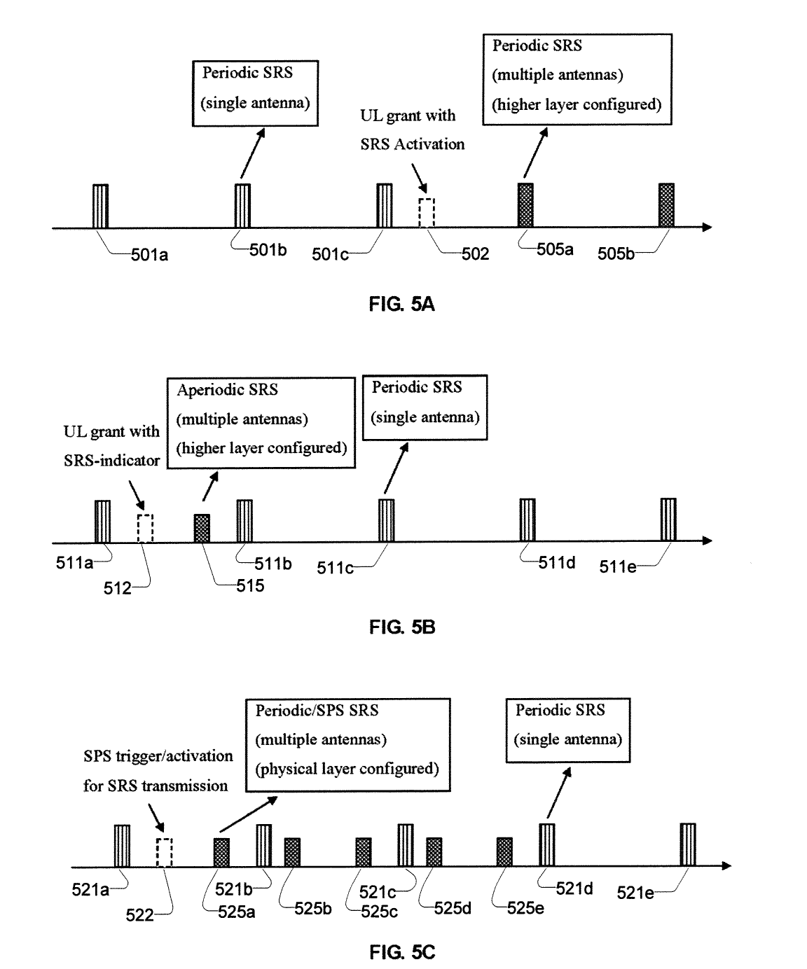

As proposed in 3GPP TSG-RAN-WG1 R1-094576, UEs may operate with dynamic physical-layer activation/de-activation of SRS transmission from multiple antennas. This allows timely response to the changing channel and traffic conditions, via a one-bit “SRS Activation.” This is illustrated in FIG. 5A where a UE periodically transmits SRS simultaneously from multiple antennas 505a-b. The SRS transmission from multiple antennas 505a-b begins after activation when the UE receives an uplink (UL) grant 502. Parameters for the periodic SRS transmission may be configured through an initial radio resource control (RRC) signaling or be implicitly determined from other parameters, for example, SRS parameters for transmission from a single antenna. Also illustrated in FIG. 5A are periodic SRS transmissions 501a-c from a single antenna that occur before the UE receives the uplink (UL) grant 502.

Also as proposed in 3GPP TSG-RAN-WG1 R1-094653 UEs may operate with scheduled (aperiodic) SRS transmissions. Here, as illustrated in FIG. 5B, the UE periodically transmits SRS from a single antenna 511a-e. After receiving a UL grant with an SRS indicator 512, the UE transmits an aperiodic SRS from multiple antennas 515.

In more detail, the scheduled SRS operation uses parameters configured via higher layer signaling. There may be separate SRS resources reserved for periodic and scheduled SRS. Scheduled SRS may be triggered using an SRS-indicator included in a UL grant, for example, the UL grant with an SRS indicator 512 illustrated in FIG. 5B. Additionally, a new physical downlink control channel (PDCCH) format is defined (similar to PDCCH Format 3A) for triggering the scheduled SRS for many UEs at the same time. This avoids a need for scheduling the physical uplink shared channel (PUSCH). The scheduled SRS is a “one-shot” transmission in that it occurs once per UL grant. This mitigates problems that may be caused by failure of dynamic SRS scheduling grant. The scheduled SRS temporarily overrides the periodic SRS configuration when the periodic and aperiodic SRS collide during the same SRS-symbol.

However, the “one-shot” nature of the SRS scheme of 3GPP TSG-RAN-WG1 R1-094653 and the configuration via higher-layer signaling of the parameters for the SRS resource provides limited flexibility. This may be particularly so when the UL channel has changing channel characteristics and traffic conditions. However, an efficient and flexible scheme may be provided as described below.

In another SRS scheme, a UE performs a periodic SRS transmission from multiple antennas that is separate from a periodic SRS transmission from a single antenna (performed as in LTE). This is illustrated in FIG. 5C where a UE periodically transmits SRS from a single antenna 521a-b. The UE transmits SRS from multiple antennas 525a-e beginning after activation when the UE receives an uplink grant 522 in a downlink control information (DCI) format. DCI includes a cyclic redundancy check that is scrambled with the UE identity that is used to address the message to the UE. Activation of the SRS from multiple antennas may be configured at the physical layer in the UE. The activated SRS transmission may occur in the same transmission time interval (TTI) in which the UL grant was received. In one embodiment, the triggered SRS transmits in subframe n+4 when the relevant DCI format is received in subframe n. In some implementations, the SRS may be one shot (that is, transmitted once) or semi-persistent and continue until deactivated.

The periodic SRS transmission from a single antenna helps the network measure channel conditions over a wider bandwidth, and the periodic SRS transmission from multiple antennas may be used over a narrower frequency bandwidth to support UL MIMO. The periodic SRS transmission from multiple antennas may be triggered or activated by an indicator included in a DCI format. In various embodiments, the DCI format is for a UL grant, is a DCI format 0, or is for a UL MIMO transmission. To make the trigger or activation more reliable, semi-persistent scheduling may be validated using a virtual CRC. Additionally, the DCI format may include parameters of the SRS transmission from multiple antennas including the transmission timing (start time).

Configuration of various parameters of the SRS may be supplied by a higher layer, for example, layer 2 or layer 3. In various aspects, the configuration and operation of the SRS includes configuration of which antennas the UE uses to transmit SRS. Operation of the triggered SRS transmission may be such that the triggered SRS transmission does not stop or release the periodic SRS transmission from a single antenna that is performed as in LTE. Additionally, the SRS transmission may be triggered by one indicator included in the DCI format. The indicator may be the indicator in the field previously used to trigger an aperiodic CSI report. Operation of SRS transmission with semi-persistent scheduling is activated or released when certain special fields of the DCI format match defined values.

Additional parameters of the configuration may also include the periodicity of the triggered SRS transmission. The periodicity of the triggered SRS transmission, in some embodiments, is shorter than the periodicity of the periodic SRS transmission from a single antenna that performs as in LTE. The configuration also includes a transmission bandwidth and a frequency hopping bandwidth of the triggered SRS transmission. In some implementations, the frequency hopping bandwidth of the triggered SRS transmission is shorter than the frequency hopping bandwidth of the periodic SRS transmission from a single antenna that performs as in LTE. Additionally, the configuration parameters may be specific to each transmit antenna.

In one embodiment, when a first triggered semi-persistent scheduled SRS transmission is ongoing and the UE receives a DCI to trigger a second semi-persistent scheduled SRS transmission, the first triggered semi-persistent scheduled SRS transmission is released and the UE performs the second triggered semi-persistent scheduled SRS transmission. In another embodiment, when a first triggered semi-persistent scheduled SRS transmission is ongoing and the UE receives a DCI to trigger a second semi-persistent scheduled SRS transmission, the parameters of the second semi-persistent scheduled SRS are used to reconfigure the first triggered semi-persistent scheduled SRS transmission except for the transmission timing.

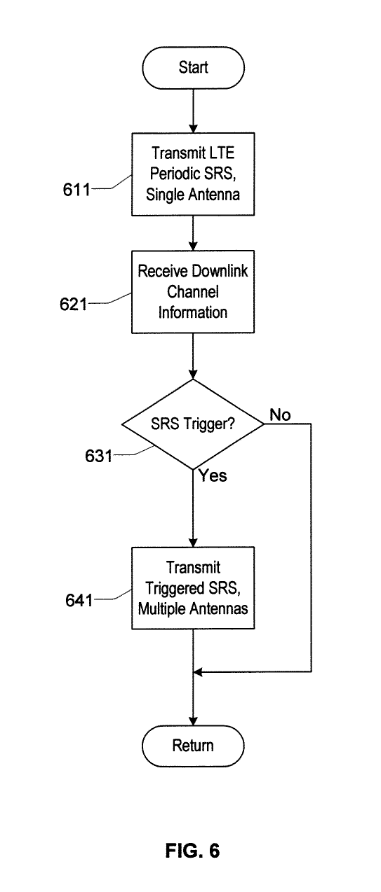

FIG. 6 is a flowchart of a process for transmitting sounding reference signals in accordance with aspects of the invention. The process is utilized in a UE of a wireless communication system. The process, in step 611, transmits a periodic SRS from a single antenna as for LTE. In some embodiments, transmission of the periodic SRS as for LTE may be omitted or disabled at some times during operation of the UE.

In step 621, the process receives DCI. The UE decodes the DCI and determines whether it is for that UE, for example, when a CRC is correct. DCI that are not directed to the UE are not further processed. In step 631, the process determines whether the DCI is related to a triggered SRS. If the DCI relates to a triggered SRS, the process continues to block 641; otherwise, the process returns.

In step 641, the process transmits the triggered SRS according to the DCI received in step 621. For example, the process may transmit SRS from multiple antennas. Characteristics of the triggered SRS may include the various parameters and operations of the triggered SRS described above. Thereafter the process returns.

The steps of a method or algorithm described in connection with aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, a DVD, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may include packaging materials.

Although the invention has been discussed with respect to various embodiments, it should be understood the invention comprises the novel and unobvious claims, and their insubstantial variations, supported by this disclosure.

What is claimed is:

1. A method for transmitting sounding reference signals from a user equipment having a plurality of antennas, the method comprising:
transmitting a first sounding reference signal from one of the plurality of antennas, wherein transmitting the first sounding reference signal repeats at a first period; and
transmitting a second sounding reference signal from at least two of the plurality of antennas, wherein transmitting the second sounding reference signal repeats at a second period.

2. The method of claim 1, wherein the second period is shorter than the first period.

3. The method of claim 1, wherein transmitting the first sounding reference signal uses frequency hopping having a first frequency hopping bandwidth, wherein transmitting the second sounding reference signal uses frequency hopping having a second frequency hopping bandwidth, and wherein the second frequency hopping bandwidth is less than the first frequency hopping bandwidth.

4. The method of claim 1, further comprising receiving downstream channel information having a DCI format, wherein transmitting the second sounding reference signal is activated based on the downstream channel information.

5. The method of claim 4, wherein the DCI format has an associated transmission time interval and the second sounding reference signal is transmitted in the associated transmission time interval.

6. The method of claim 4, further comprising receiving additional downstream channel information, the additional downstream channel information including a configuration for the second sounding reference signal selected from the group consisting of a period, a transmission bandwidth, and a frequency hopping bandwidth.

7. The method of claim 4, further comprising, when transmitting the second sounding reference signal is for a first triggered transmission and when the received downstream channel information triggers a second transmission, terminating transmitting the second sounding reference signal for the first triggered transmission and transmitting the second sounding reference signal according to the second triggering.

8. The method of claim 4, further comprising, when transmitting the second sounding reference signal is for a first configuration and when the received downstream channel information signals a second configuration, terminating transmitting the second sounding reference signal for the first configuration and transmitting the second sounding reference signal according to the second configuration, wherein transmitting the second sounding reference signal according to the second configuration utilizes transmission timing of the first configuration.

9. The method of claim 8, wherein the DCI format has an associated transmission time interval and the second sounding reference signal is transmitted according to the second configuration in the associated transmission time interval.

10. A wireless communication device comprising:
a plurality of transmitters configured to supply radio-frequency signals;
a plurality of antennas configured to receive the radio-frequency signals from the plurality of transmitters;
a processor configured to execute a program; and
a memory coupled to the processor for storing the program, wherein the program instructs the processor to:
command transmission of a first sounding reference signal from one of the plurality of antennas, wherein transmitting the first sounding reference signal repeats at a first period; and
command transmission of a second sounding reference signal from at least two of the plurality of antennas, wherein transmitting the second sounding reference signal repeats at a second period.

11. The wireless communication device of claim 10, wherein the second period is shorter than the first period.

12. The wireless communication device of claim 10, wherein the first sounding reference signal is transmitted using frequency hopping having a first frequency hopping bandwidth, wherein the second sounding reference signal is transmitted using frequency hopping having a second frequency hopping bandwidth, and wherein the second frequency hopping bandwidth is less than the first frequency hopping bandwidth.

13. The wireless communication device of claim 10, further comprising a receiver coupled to at least one of the plurality of antennas and configured to supply received data to the processor, wherein the program further instructs the processor to analyze the data from the receiver for downstream channel information having a DCI format, and wherein the program instructions to command transmission of the second sounding reference signal include conditions based on the downstream channel information.

14. The wireless communication device of claim 13, wherein the DCI format has an associated transmission time interval and the instructions to command transmission of the second sounding reference signal are performed in the associated transmission time interval.

15. The wireless communication device of claim 13, wherein the program further instructs the processor to analyze additional downstream channel information, the additional downstream channel information including a configuration for the second sounding reference signal selected from the group consisting of a period, a transmission bandwidth, and a frequency hopping bandwidth.

16. A method for transmitting sounding reference signals from a user equipment having a plurality of antennas, the method comprising:
receiving downstream channel information having a DCI format; and
transmitting a sounding reference signal when triggered by the DCI format,
wherein the DCI format has an associated transmission time interval and the sounding reference signal is transmitted in the associated transmission time interval.

17. The method of claim 16, wherein the triggered sounding reference signal is transmitted from at least two antennas of the plurality of antennas of the user equipment.

18. The method of claim 16, wherein the triggered sounding reference signal is transmitted in an n+4th subframe when the downstream channel information is received in an nth subframe.

19. The method of claim 16, further comprising receiving additional downstream channel information, the additional downstream channel information including a configuration for the sounding reference signal selected from the group consisting of a periodicity of the sounding reference signal, a transmission bandwidth of the sounding reference signal, and a frequency hopping bandwidth of the sounding reference signal

20. The method of claim 19, wherein the configuration is for each of the plurality of antennas.
